(19) United States
(12) Patent Application Publication
(10) Pub. No.: US 2012/0330795 A1
(43) Pub. Date: Dec. 27, 2012

(54) SHOE WITH RECONFIGURABLE INSOLE AND METHOD

(76) Inventor: Roy S. Hayes, Grand Rapids, MI (US)

(21) Appl. No.: 13/494,286

(22) Filed: Jun. 12, 2012

Related U.S. Application Data
(60) Provisional application No. 61/497,202, filed on Jun. 15, 2011.

(51) Int. Cl. A43B 3/24; G06Q 10/08

(52) U.S. Cl. 705/28; 36/83

(57) ABSTRACT

A reconfigurable article of footwear has a reconfigurable insole inserted through an opening for receiving the foot of the user that is supported on a midsole. The reconfigurable insole has a primary footbed and a removable footbed. The primary footbed has a top side for supporting the foot of the user and a bottom side for contacting at least a portion of the midsole and for engaging the removable footbed. The removable footbed has a top side for engaging a portion of the bottom side of the primary footbed and a bottom side for contacting the midsole. Detachable corresponding and aligned fasteners on each of the bottom side of the primary footbed and the top side of the removable footbed detachably secure the removable footbed to the primary footbed.

### CROSS-REFERENCE TO RELATED APPLICATIONS AND CLAIM TO PRIORITY

Applicant hereby claims the priority benefits under the provisions of 35 U.S.C. §119(e), basing said claim of priority on related provisional U.S. Application Ser. No. 61/497,202, filed Jun. 15, 2011, the entire disclosure of which is incorporated herein by reference.

### BACKGROUND OF THE INVENTION

The present invention relates to a reconfigurable article of footwear and, more particularly, to an article of footwear having a removable and reconfigurable insole.

Conventional articles of footwear are sold with original insoles that often provide insufficient foot protection and/or do not address the different needs of the various areas of the foot, which may be unique to individual users. These conventional insoles often do not provide sufficient fit, protection, or support for everyday and/or specialized wear by an individual user. Consequently, individual users often purchase additional aftermarket insole materials to compensate for the deficiencies stated above.

As shoes are worn during the day, an individual's feet naturally get hot and perspire, swelling slightly during the day. As a result, a shoe that fits an individual comfortably at one point in the day may become uncomfortable at other times. Additionally, certain individuals experience foot health issues such as bunions, corns, hammer toes, neuromas, uneven feet, or warts, often affecting only one of two feet, which make it difficult, if not impossible, with a normal pair of shoes to obtain an acceptable volume fitting for each foot. Cumbersome and/or complicated devices on the market have attempted to address these concerns, but have not adequately resolved the problems.

Accordingly, a shoe having an improved insole construction to solve and/or make improvements on the aforementioned disadvantages associated with existing insoles is desired.

### SUMMARY OF THE INVENTION

One aspect of the present invention is a reconfigurable article of footwear having an external bottom sole that defines a midsole, an external upper attached to the external bottom sole, and an opening for receiving a foot of a user. The article of footwear includes a reconfigurable insole inserted through the opening for receiving the foot of the user that is supported on the midsole. The reconfigurable insole has a primary footbed and a removable footbed. The primary footbed has a top side for supporting the foot of the user and a bottom side for contacting at least a portion of the midsole and for engaging the removable footbed. The removable footbed has a top side for engaging a portion of the bottom side of the primary footbed and a bottom side for contacting the midsole. Detachable corresponding and aligned fasteners on each of the bottom side of the primary footbed and the top side of the removable footbed detachably secure the removable footbed to the primary footbed.

Another aspect of the present invention is a reconfigurable article of footwear having a removable footbed that defines an external perimeter and the corresponding detachable fasteners comprise a plurality of Velcro fasteners disposed proximate a portion of the external perimeter.

Yet a further aspect of the present invention is a reconfigurable article of footwear having a plurality of Velcro fasteners that are substantially round or oval and are disposed proximate a portion of the external perimeter in a generally triangular-spaced arrangement.

Still another aspect of the present invention is a reconfigurable article of footwear having a removable footbed that has a toe end and a proximal end, and a plurality of Velcro fasteners comprising a pair of Velcro strips, where one of the pair of Velcro strips is disposed proximate the toe end and the other of the pair of Velcro strips is disposed proximate the proximal end.

An additional aspect of the present invention is a reconfigurable article of footwear having a removable footbed that has a toe end and a proximal end, the proximal end defining a generally straight edge, and the bottom side of the primary footbed has a corresponding straight edge formed therein along a recess that interacts with and at least partially accepts the removable footbed.

Another aspect of the present invention is a reconfigurable article of footwear having a removable footbed that varies in thickness between 0.5 millimeters and 4.0 millimeters, and preferably has a thickness of approximately 2.0 millimeters.

An additional aspect of the present invention is a removable footbed is constructed of rubber, foam, or any other elastomeric material, and preferably constructed of ethylene-vinyl acetate (EVA).

Yet another aspect of the present invention is a method for reconfiguring an article of footwear having an external bottom sole having a midsole, an external upper attached to the external bottom sole, and an opening for receiving a foot of a user. The method comprises the steps of providing a reconfigurable insole having a primary footbed and a removable footbed. The primary footbed has a top side for supporting the foot of the user and a bottom side for contacting at least a portion of the midsole and for engaging the removable footbed and the removable footbed has a top side for engaging a portion of the bottom side of the primary footbed and a bottom side for contacting the midsole. The next step is attaching detachable corresponding and aligned fasteners on each of the bottom side of the primary footbed and the top side of the removable footbed one to the other for detachably securing the removable footbed to the primary footbed. The following step is inserting the reconfigurable insole with the removable footbed through the opening for receiving the foot of the user supported on the midsole. The subsequent step is removing the reconfigurable insole through the opening for receiving the foot of the user supported on the midsole. The next step is detaching the removable footbed from the primary footbed. The final step is reinserting the reconfigurable insole without the removable footbed through the opening for receiving the foot of the user supported on the midsole.

Another aspect of the present invention is a method for changing the fitting of an article of footwear having an external bottom sole defining a midsole, an external upper attached to the external bottom sole, and an opening for receiving a foot of a user. The method includes the steps of providing a reconfigurable insole having a primary footbed and a removable footbed, where the primary footbed has a top side for supporting the foot of the user and a bottom side for contacting at least a portion of the midsole and for engaging the removable footbed and the removable footbed has a top side for engaging a portion of the bottom side of the primary footbed and a bottom side for contacting the midsole. The next step is attaching detachable corresponding and aligned fasteners on each of the bottom side of the primary footbed and the top side of the removable footbed one to the other for detachably securing the removable footbed to the primary footbed. The subsequent step is inserting the reconfigurable insole with the removable footbed through the opening for receiving the foot of the user supported on the midsole to define an article of footwear having a first volume fitting (e.g., a “medium”). The following step is removing the reconfigurable insole through the opening for receiving the foot of the user supported on the midsole. The next step is detaching the removable footbed from the primary footbed. The final step is reinserting the reconfigurable insole without the removable footbed through the opening for receiving the foot of the user supported on the midsole to define an article of footwear having a second, larger volume fitting (e.g., a “wide”).

Yet a further aspect of the present invention is a method for controlling the inventory for articles of footwear having an external bottom sole defining a midsole, an external upper attached to the external bottom sole, and an opening for receiving a foot of a user. The method includes the steps of providing a reconfigurable insole having a primary footbed and a removable footbed, where the primary footbed has a top side for supporting the foot of the user and a bottom side for contacting at least a portion of the midsole and for engaging the removable footbed and the removable footbed has a top side for engaging a portion of the bottom side of the primary footbed and a bottom side for contacting the midsole. The next step is employing detachable corresponding and aligned fasteners on each of the bottom side of the primary footbed and the top side of the removable footbed to detachably secure the removable footbed to the primary footbed. The subsequent step is inserting the reconfigurable insole with the removable footbed through the opening for receiving the foot of the user supported on the midsole to define an article of footwear having a first volume fitting (e.g., a “medium). The following step is removing the reconfigurable insole through the opening for receiving the foot of the user supported on the midsole. The next step is detaching the removable footbed from the primary footbed. The final step is reinserting the reconfigurable insole without the removable footbed through the opening for receiving the foot of the user supported on the midsole to define an article of footwear having a second volume fitting (e.g., a “wide”).

An additional aspect of the present invention is a method for controlling the inventory for articles of footwear comprising the additional step of designating a single article of footwear as two separate shoe fittings (e.g., “medium” and “wide”) to reduce inventory.

A still further aspect of the present invention is a method for controlling the inventory for articles of footwear wherein the removable footbed is provided with a toe end and a proximal end, the proximal end defining a generally straight edge, and the bottom side of the primary footbed is provided with a corresponding straight edge formed therein along a recess that interacts with and at least partially accepts the removable footbed.

Another aspect of the present invention is a method for improving the wearing comfort of an article of footwear having an external bottom sole defining a midsole, an external upper attached to the external bottom sole, and an opening for receiving a foot of a user. The method includes the steps of providing a reconfigurable insole having a primary footbed and a removable footbed, where the primary footbed has a top side for supporting the foot of the user and a bottom side for contacting at least a portion of the midsole and for engaging the removable footbed and the removable footbed has a top side for engaging a portion of the bottom side of the primary footbed and a bottom side for contacting the midsole. The next step is employing detachable corresponding and aligned fasteners on each of the bottom side of the primary footbed and the top side of the removable footbed to detachably secure the removable footbed to the primary footbed. The subsequent step is inserting the reconfigurable insole with the removable footbed through the opening for receiving the foot of the user supported on the midsole to define an article of footwear having a first volume fitting (e.g., a “medium”). The following step is removing the reconfigurable insole through the opening for receiving the foot of the user supported on the midsole. This step is followed by detaching the removable footbed from the primary footbed. The final step is reinserting the reconfigurable insole without the removable footbed through the opening for receiving the foot of the user supported on the midsole to define an article of footwear having a second, larger volume fitting (e.g., a “wide”).

A still further aspect of the present invention is a method for improving the foot health of an individual experiencing foot health issues, such as bunions, corns, hammer toes, neuromas, uneven feet, or warts, which often affect only one of two feet, making it difficult, if not impossible, to obtain an acceptable volume fitting for each foot with a normal pair of shoes, where the method comprise the steps of providing an article of footwear having an external bottom sole defining a midsole, an external upper attached to the external bottom sole, and an opening for receiving a foot of a user. The method also includes the step of providing a reconfigurable insole having a primary footbed and a removable footbed, the primary footbed having a top side for supporting the foot of the user and a bottom side for contacting at least a portion of the midsole and for engaging the removable footbed and the removable footbed having a top side for engaging a portion of the bottom side of the primary footbed and a bottom side for contacting the midsole. The next step is employing detachable corresponding fasteners on each of the bottom side of the primary footbed and the top side of the removable footbed aligned one to the other to detachably secure the removable footbed to the primary footbed. The subsequent step is inserting the reconfigurable insole with the removable footbed through the opening for receiving the foot of the user supported on the midsole to define an article of footwear having a first volume. Next, the reconfigurable insole is removed through the opening for receiving the foot of the user supported on the midsole, followed by the step of detaching the removable footbed from the primary footbed. Finally, the reconfigurable insole is reinserted without the removable footbed through the opening for receiving the foot of the user supported on the midsole to define an article of footwear having a second, larger volume.

In accordance with the aforementioned aspects of the present invention, the disclosed article of footwear presents a unique construction with a reconfigurable insole having at least one removable portion, where the insole is economical to manufacture, efficient in use, and particularly adapted for the proposed use, as well as a method for constructing such an article of footwear. The disclosed article of footwear, such as a shoe, accommodates changes in the fitting of an individual user's foot by decreasing or increasing the interior volume of the shoe by adding or removing the removable portion on the underside of the insole, respectively. Thus, the fitting of the shoe can be markedly improved, for example, changing the fitting from a “medium” to a “wide” and back again. As noted, the shoe may also be sold as dual fitting (e.g., “medium” and “wide”), allowing retailers to purchase and carry only one pair of shoes rather than two to meet customer fitting needs, thereby reducing the amount of stock required to be maintained on-site. The variable volume fitting also serves to increase the comfort level of an individual when wearing socks versus being barefoot in the shoe. The variable volume fitting also serves to alleviate shoe fitting concerns resulting from certain foot health issues such as bunions, corns, hammer toes, neuromas, uneven feet, or warts, often affecting only one of two feet, which make it difficult, if not impossible, with a normal pair of shoes to obtain an acceptable volume fitting for each foot. The simple construction and manipulation of the shoe overcomes several of the problems associated with the cumbersome and complicated devices noted above.

These and other aspects of the invention will be further understood and appreciated by those skilled in the art by reference to the following written specification, claims, and appended drawings.

### BRIEF DESCRIPTION OF THE DRAWINGS

FIG. 1 is a perspective view of a reconfigurable article of footwear.

FIG. 2 is a perspective view of an interior portion of the reconfigurable article of footwear.

FIG. 3 is a side view of the reconfigurable insole of the reconfigurable article of footwear, shown with the removable footbed or insole attached.

FIG. 4 is an exploded elevational view of the reconfigurable article of footwear, shown with the removable footbed or insole detached from the primary footbed.

FIG. 5 is a bottom perspective view of the bottom side of the primary footbed of the reconfigurable article of footwear, shown with the removable footbed or insole detached from the primary footbed.

FIG. 6 is a bottom elevational view of the bottom side of the primary footbed of the reconfigurable article of footwear, shown with the removable footbed or insole detached from the primary footbed.

FIG. 7 is a top elevational view of the top side of the removable footbed or insole detached from the primary footbed.

FIG. 8 is a bottom elevational view of the bottom side of the removable footbed or insole detached from the primary footbed.

FIG. 9 is a perspective view of an interior portion of the reconfigurable article of footwear with the reconfigurable insole inserted.

FIG. 10 is a perspective view of the reconfigurable article of footwear with the primary footbed being inserted.

FIG. 11 is a bottom elevational view of the bottom side of the primary footbed of the reconfigurable article of footwear, shown with the removable footbed or insole attached to the primary footbed.

FIG. 12 is an exploded elevational view of another embodiment of the reconfigurable article of footwear, shown with the removable footbed or insole detached from the primary footbed.

### DETAILED DESCRIPTION OF THE PREFERRED EMBODIMENTS

For purposes of description herein, the terms “upper,” “lower,” “right,” “left,” “rear,” “front,” “vertical,” “horizontal” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

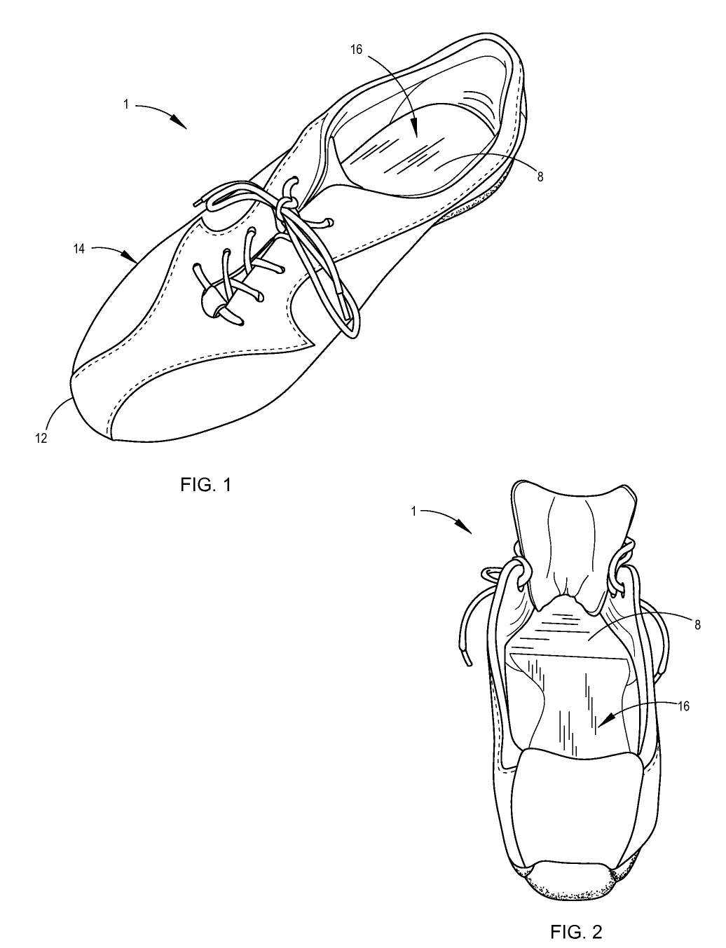

Referring to FIGS. 1 and 2, an article of footwear, such as shoe 1, comprises a bottom external sole 2 and a flexible upper 4, the latter constructed from leather, canvas, or other flexible and robust material, as is known. The shoe 1 has a midsole 8 internal to the shoe 1 along the upper surface of the external sole 2 and a toe region 12, a medial area 14, and a foot insertion opening 16 for receiving a foot of a user. The shoe 1 may be any type of conventional footwear, including, but not limited to, dress shoes, casual shoes, loafers, sandals, athletic shoes, work boots, hiking boots, etc.

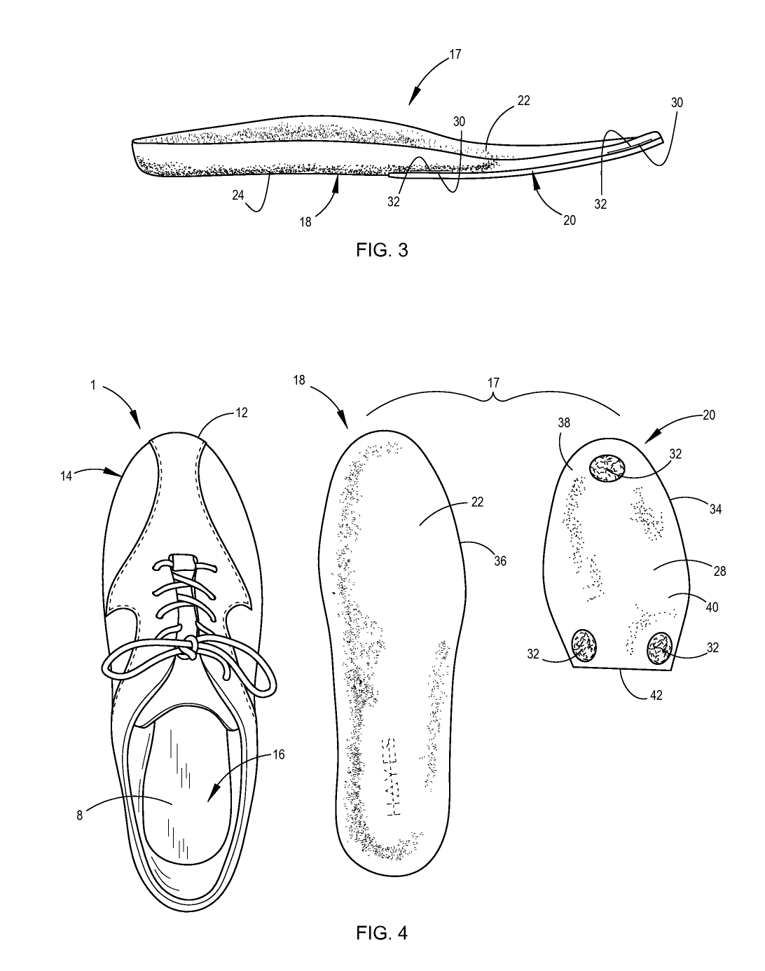

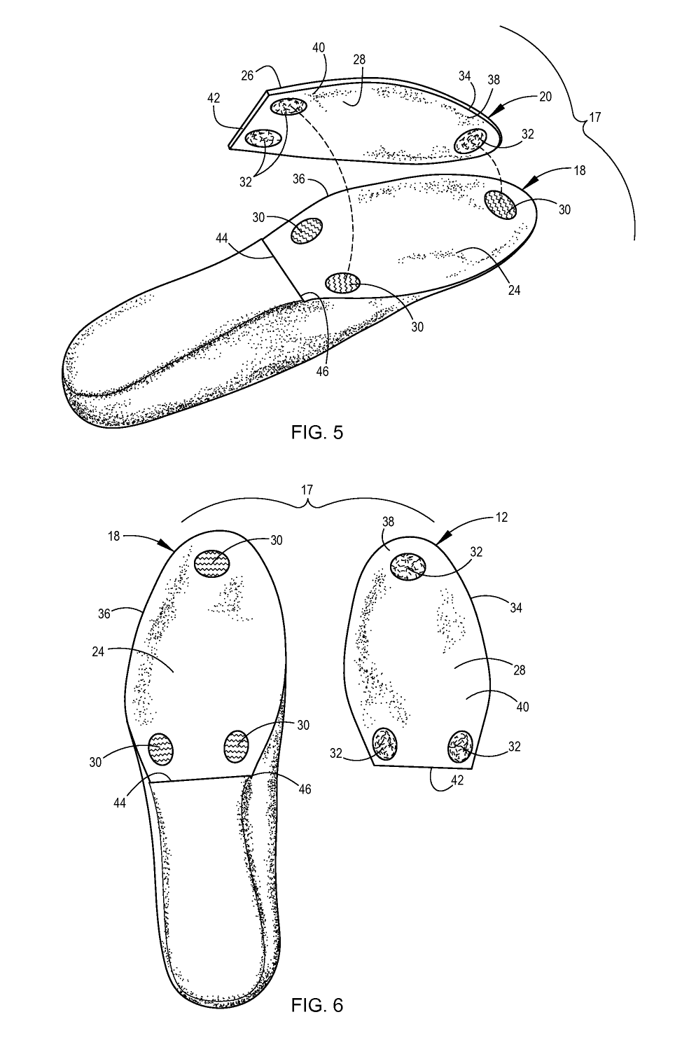

Referring to FIGS. 3-6 and 11, a removable and reconfigurable insole 17 may be reversibly inserted into the shoe 1, as shown in FIG. 11. The reconfigurable insole 17 includes a primary footbed 18 and a removable footbed or insole 20 that extends substantially from the toe region 12 to a location proximate the medial area 14. In order to provide the best fit and function of the shoe 1, and to match the perimeter of the midsole 8 as closely as possible, the reconfigurable insole 17 is intended to be manufactured as part of the original shoe 1. That is, given the large variety of the midsole 8 shapes and difficulty in matching the perimeter shape of an aftermarket reconfigurable insole 17 to so many different shapes, while enjoying the benefits of the presently disclosed reconfigurable insole 17, neither the primary footbed 18 nor the removable footbed 20 are intended to be sold as aftermarket products. The reconfigurable insole 17 is configured to slidably fit into and out of the foot insertion area 16 and supportably atop the midsole 8 located along a bottom, interior region of the shoe 1 above the bottom exterior sole 2.

The primary footbed 18 includes a top side 22 and a bottom side 24. Securely fixed to the bottom side 24 of the primary footbed 18 is at least one, but preferably a plurality, of round or oval Velcro fasteners 30 fixed in a generally triangular-spaced arrangement. Other types of fasteners may be employed. The removable footbed 20 also includes a bottom side 26 and a top side 28. Securely fixed to the top side 28 of the removable footbed 20 is at least one, but again preferably a plurality, of substantially round or oval Velcro fasteners 32 fixed in a generally triangular-spaced arrangement. The Velcro fasteners 32 of the removable footbed 20 are located in an arrangement that substantially corresponds to the Velcro fasteners 30 of the primary footbed 18, such that the Velcro fasteners are aligned one to the other, and a perimeter 34 of the removable footbed 20 is in alignment with a perimeter 36 of the primary footbed 18 when the primary footbed 18 and the removable footbed 20 are attached.

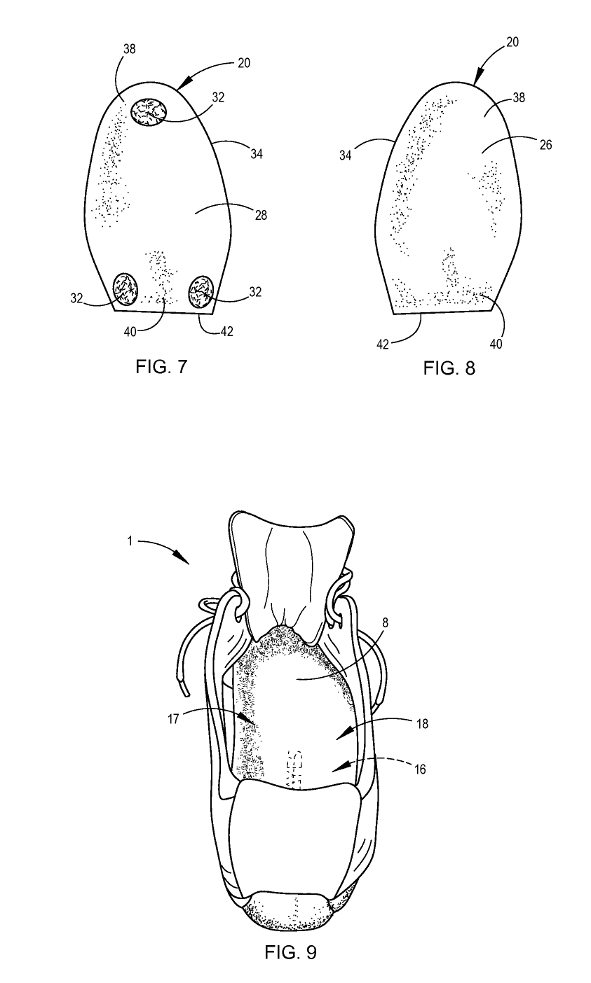

Referring now to FIGS. 7 and 8, the removable footbed 20 provides additional cushioning and/or support, while also displacing a predetermined interior volume of the shoe 1. The removable footbed 20 may be constructed of any suitable cushioning or supporting material, such as a rubber, foam, or any other elastomeric material. An example of a suitable material for the removable footbed 20 is ethylene-vinyl acetate (EVA). The removable footbed 20 may vary in thickness between ranges of 0.5 millimeters and 4.0 millimeters, but preferably has a thickness of approximately 2.0 millimeters.

Preferably, the removable footbed 20 extends from the toe region 12 to the medial area 14 and has a toe end 38 and a proximal end 40. The proximal end 40, as shown in FIG. 7, defines a generally straight edge 42. A corresponding straight edge 44 is preferably formed in the bottom side 24 of the primary footbed 18 along a slight recess 46 that is designed to interact with and partially accept the thickness of the removable footbed 20, as best seen in FIGS. 3 and 11.

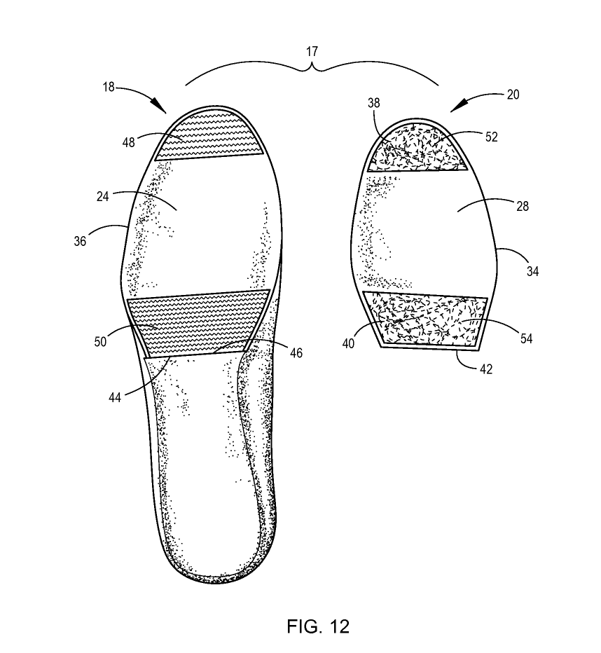

A further embodiment of the primary footbed 18 is shown in FIG. 12, and like the previous embodiment, includes a top side 22 and a bottom side 24. Securely fixed to the bottom side 24 of the primary footbed 18 is a pair of substantially rectangular strips of Velcro fasteners 48, 50. Velcro fastener 48 is mounted to the bottom side 24 of the primary footbed 18 proximate the toe end 38 of the removable footbed 20, and Velcro fastener 50 is mounted to the bottom side 24 of the primary footbed 18 proximate the proximal end 40 of the removable footbed 20. Securely fixed to the top side 28 of the removable footbed 20 is a corresponding pair of substantially rectangular strips of Velcro fasteners 52, 54, with Velcro fastener 52 being mounted to the top side 28 of the removable footbed 20 proximate the toe end 38 of the removable footbed 20, and Velcro fastener 54 being mounted to the top side 28 of the proximate the proximal end 40. The Velcro fasteners 48, 50 of the primary footbed 18 of the removable footbed 20 are thus likewise located in an arrangement that corresponds substantially to the Velcro fasteners 52, 54 of the removable footbed 20, such that a perimeter 34 of the removable footbed 20 is in alignment with a perimeter 36 of the primary footbed 18, where the primary footbed 18 and the removable footbed 20 are attached.

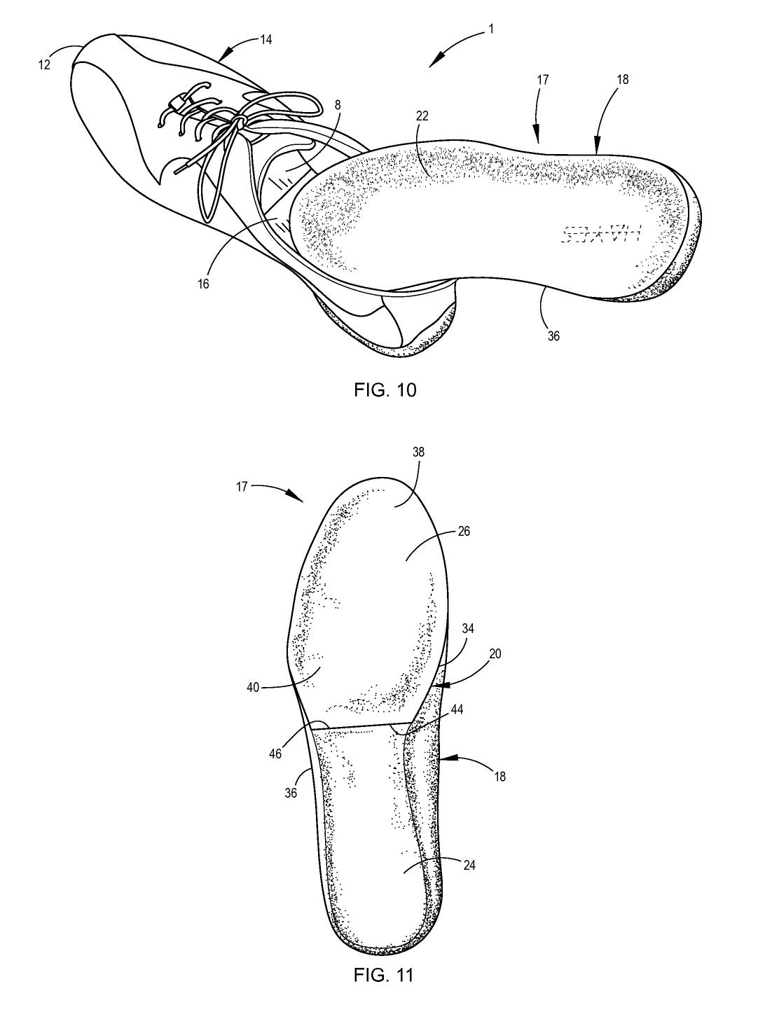

As described above, the removable footbed 20 is attachable to and removable from the primary footbed 18. The reconfigurable insole 17 may be inserted or removed through the foot insertion area 16. The Velcro fasteners 30, 32 and 48, 50, 52, 54 align and secure with one another when attachment is desired. Referring to FIGS. 9, 10, and 11, the ease and practicality of a method of reconfiguring the reconfigurable insole 17 may be seen, providing for a quick and simple removal or attachment of the removable footbed 20.

Removal of the removable footbed 20 may be desirable when extra volume within the interior of the shoe 1 is required in order to provide improved fit and comfort. Such an occasion may occur to those individuals who are on their feet for extended periods of time, with the consequence of the individual's feet increasing in temperature, perspiring, and, therefore, swelling over the course of a day. Another occasion results from individuals who experience foot health issues such as bunions, corns, hammer toes, neuromas, uneven feet or warts, often affecting only one of their two feet, which make it difficult, if not impossible, to obtain an acceptable volume fitting for each foot with a normal pair of shoes. By removing primary footbed 18 and detaching or reattaching the removable footbed 20, a user is provided with the option of a shoe 1 that adjusts with the individual's changing needs during the course of the day and increases the volume of the shoe to improve the comfort of the shoes when the individual's foot gets hot. Additionally, an individual is provided with the option of leaving the removable footbed 20 in the shoe 1 when opting to wear the shoe 1 without socks, while removing the removable footbed 20 when wearing socks is desired.

By removing the removable footbed 20 from the underside of the primary footbed 18, the shoe can also be sold as dual fitting and, therefore, the retailer has to purchase only one shoe that is capable of doubling as two separate shoe fittings (e.g., “medium” and “wide”). Thus, the retailer can inventory less stock. Finally, the construction and performance of the disclosed removable dual-fit system is simple and is readily manufactured.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is as follows:

1. A reconfigurable article of footwear having an external bottom sole defining a midsole, an external upper attached to the external bottom sole, and an opening for receiving a foot of a user, the article of footwear further comprising:
a reconfigurable insole inserted through the opening for receiving the foot of the user supported on the midsole, the reconfigurable insole having a primary footbed and a removable footbed;
the primary footbed having a top side for supporting the foot of the user and a bottom side for contacting at least a portion of the midsole and for engaging the removable footbed;
the removable footbed having a top side for engaging a portion of the bottom side of the primary footbed and a bottom side for contacting the midsole; and
detachable corresponding fasteners on each of the bottom side of the primary footbed and the top side of the removable footbed aligned one to the other and detachably securing the removable footbed to the primary footbed.

2. The reconfigurable article of footwear of claim 1, wherein the removable footbed defines an external perimeter and the corresponding detachable fasteners comprise a plurality of Velcro fasteners disposed proximate a portion of the external perimeter.

3. The reconfigurable article of footwear of claim 3, wherein the plurality of Velcro fasteners are substantially round or oval and are disposed proximate a portion of the external perimeter in a generally triangular-spaced arrangement.

4. The reconfigurable article of footwear of claim 2, wherein the removable footbed has a toe end and a proximal end, the plurality of Velcro fasteners comprising a pair of Velcro strips, where one of the pair of Velcro strips is disposed proximate the toe end and the other of the pair of Velcro strips is disposed proximate the proximal end.

5. The reconfigurable article of footwear of claim 1, wherein the removable footbed has a toe end and a proximal end, the proximal end defining a generally straight edge, and the bottom side of the primary footbed has a corresponding straight edge formed therein along a recess that interacts with and at least partially accepts the removable footbed.

6. The reconfigurable article of footwear of claim 1, wherein the removable footbed varies in thickness between 0.5 millimeters and 4.0 millimeters.

7. The reconfigurable article of footwear of claim 6, wherein the removable footbed has a thickness of approximately 2.0 millimeters.

8. The reconfigurable article of footwear of claim 1, wherein the removable footbed is constructed of rubber, foam, or any other elastomeric material.

9. The reconfigurable article of footwear of claim 8, wherein the removable footbed is constructed of ethylene-vinyl acetate (EVA).

10. A method for reconfiguring an article of footwear having an external bottom sole defining a midsole, an external upper attached to the external bottom sole, and an opening for receiving a foot of a user, the method comprising the steps of:
providing a reconfigurable insole having a primary footbed and a removable footbed, the primary footbed having a top side for supporting the foot of the user and a bottom side for contacting at least a portion of the midsole and for engaging the removable footbed, and the removable footbed having a top side for engaging a portion of the bottom side of the primary footbed and a bottom side for contacting the midsole;
attaching detachable corresponding fasteners on each of the bottom side of the primary footbed and the top side of the removable footbed aligned one to the other for detachably securing the removable footbed to the primary footbed;
inserting the reconfigurable insole with the removable footbed through the opening for receiving the foot of the user supported on the midsole;
removing the reconfigurable insole through the opening for receiving the foot of the user supported on the midsole;
detaching the removable footbed from the primary footbed; and
reinserting the reconfigurable insole without the removable footbed through the opening for receiving the foot of the user supported on the midsole.

11. The method of reconfiguring an article of footwear of claim 10, wherein the removable footbed defines an external perimeter and the corresponding detachable fasteners comprise a plurality of Velcro fasteners disposed proximate a portion of the external perimeter.

12. A method for changing the volume fitting of an article of footwear having an external bottom sole defining a midsole, an external upper attached to the external bottom sole, and an opening for receiving a foot of a user, the method comprising the steps of:
providing a reconfigurable insole having a primary footbed and a removable footbed, the primary footbed having a top side for supporting the foot of the user and a bottom side for contacting at least a portion of the midsole and for engaging the removable footbed and the removable footbed having a top side for engaging a portion of the bottom side of the primary footbed and a bottom side for contacting the midsole;
attaching detachable corresponding fasteners on each of the bottom side of the primary footbed and the top side of the removable footbed aligned one to the other for detachably securing the removable footbed to the primary footbed;
inserting the reconfigurable insole with the removable footbed through the opening for receiving the foot of the user supported on the midsole to define an article of footwear having a first volume fitting;
removing the reconfigurable insole through the opening for receiving the foot of the user supported on the midsole;
detaching the removable footbed from the primary footbed; and
reinserting the reconfigurable insole without the removable footbed through the opening for receiving the foot of the user supported on the midsole to define an article of footwear having a second, larger volume fitting.

13. The method of changing the volume fitting of an article of footwear of claim 12, further comprising the step of designating the article of footwear as being capable of a dual volume fitting, wherein a single article of footwear can function as two separate shoe volume fittings.

14. The method changing the volume fitting of an article of footwear of claim 12, wherein the removable footbed defines an external perimeter and the corresponding detachable fasteners comprise a plurality of Velcro fasteners disposed proximate a portion of the external perimeter.

15. The method for changing the volume fitting of an article of footwear of claim 12, wherein the plurality of Velcro fasteners are substantially round or oval and are disposed proximate a portion of the external perimeter in a generally triangular-spaced arrangement.

16. The method of changing the volume fitting of an article of footwear of claim 12, wherein the removable footbed has a toe end and a proximal end, the proximal end defining a generally straight edge, and the bottom side of the primary footbed has a corresponding straight edge formed therein along a recess that interacts with and at least partially accepts the removable footbed.

17. A method for controlling the inventory for articles of footwear having an external bottom sole defining a midsole, an external upper attached to the external bottom sole, and an opening for receiving a foot of a user, the method comprising the steps of:
providing a reconfigurable insole having a primary footbed and a removable footbed, the primary footbed having a top side for supporting the foot of the user and a bottom side for contacting at least a portion of the midsole and for engaging the removable footbed and the removable footbed having a top side for engaging a portion of the bottom side of the primary footbed and a bottom side for contacting the midsole;
employing detachable corresponding fasteners on each of the bottom side of the primary footbed and the top side of the removable footbed aligned one to the other to detachably secure the removable footbed to the primary footbed;
inserting the reconfigurable insole with the removable footbed through the opening for receiving the foot of the user supported on the midsole to define an article of footwear having a first volume fitting;
removing the reconfigurable insole through the opening for receiving the foot of the user supported on the midsole;
detaching the removable footbed from the primary footbed; and
reinserting the reconfigurable insole without the removable footbed through the opening for receiving the foot of the user supported on the midsole to define an article of footwear having a second, larger volume fitting.

18. The method for controlling the inventory for articles of footwear of claim 17, further comprising the step of designating a single article of footwear as two separate shoe volume fittings to reduce inventory.

19. The method for controlling the inventory for articles of footwear of claim 17, wherein the method includes the additional step of providing a removable footbed that has a toe end and a proximal end, where the proximal end defines a generally straight edge, and providing a corresponding straight edge formed on the bottom side of the primary footbed along a recess that interacts with and at least partially accepts the removable footbed.

20. A method for improving the wearing comfort of an article of footwear having an external bottom sole defining a midsole, an external upper attached to the external bottom sole, and an opening for receiving a foot of a user, the method comprising the steps of:
providing a reconfigurable insole having a primary footbed and a removable footbed, the primary footbed having a top side for supporting the foot of the user and a bottom side for contacting at least a portion of the midsole and for engaging the removable footbed and the removable footbed having a top side for engaging a portion of the bottom side of the primary footbed and a bottom side for contacting the midsole;
employing detachable corresponding fasteners on each of the bottom side of the primary footbed and the top side of the removable footbed aligned one to the other to detachably secure the removable footbed to the primary footbed;
inserting the reconfigurable insole with the removable footbed through the opening for receiving the foot of the user supported on the midsole to define an article of footwear having a first volume;
removing the reconfigurable insole through the opening for receiving the foot of the user supported on the midsole;
detaching the removable footbed from the primary footbed; and
reinserting the reconfigurable insole without the removable footbed through the opening for receiving the foot of the user supported on the midsole to define an article of footwear having a second, larger volume.

21. A method for improving the foot health of an individual experiencing foot health issues such as bunions, corns, hammer toes, neuromas, uneven feet, or warts, the method comprising the steps of:
providing an article of footwear having an external bottom sole defining a midsole, an external upper attached to the external bottom sole, and an opening for receiving a foot of a user:
providing a reconfigurable insole having a primary footbed and a removable footbed, the primary footbed having a top side for supporting the foot of the user and a bottom side for contacting at least a portion of the midsole and for engaging the removable footbed and the removable footbed having a top side for engaging a portion of the bottom side of the primary footbed and a bottom side for contacting the midsole;
employing detachable corresponding fasteners on each of the bottom side of the primary footbed and the top side of the removable footbed aligned one to the other to detachably secure the removable footbed to the primary footbed;
inserting the reconfigurable insole with the removable footbed through the opening for receiving the foot of the user supported on the midsole to define an article of footwear having a first volume;
removing the reconfigurable insole through the opening for receiving the foot of the user supported on the midsole;
detaching the removable footbed from the primary footbed; and
reinserting the reconfigurable insole without the removable footbed through the opening for receiving the foot of the user supported on the midsole to define an article of footwear having a second, larger volume.
